(19) United States
(12) Patent Application Publication
(10) Pub. No.: US 2006/0050769 A1
(43) Pub. Date: Mar. 9, 2006

(54) Waterproof infrared ear thermometer

(76) Inventor: Yung-Ku Lee, Taichung (TW)

Correspondence Address: Yung-Ku LEE, 235 Chung-Ho, Box 8-24, Taipei, TW

(21) Appl. No.: 10/935,341

(22) Filed: Sep. 8, 2004

(51) Int. Cl. G01J 5/00; G01K 1/00

(52) U.S. Cl. 374/208; 374/121

(57) ABSTRACT

A waterproof infrared ear thermometer comprises a casing containing a sensor head; a front end of the casing being a hollowed long tube; a sensor unit and a heat dissipating block being received in the casing; a front end of the sensor unit being a temperature sensing portion; an outer front ring of the temperature sensing portion having a forward protruded water-proof washer; and a front end of the casing being protruded with a stopper; the stopper being buckled in an inner edge of the water-proof washer so as to achieve the affect of preventing liquid from flowing into the sensor head. A heat dissipating block is firmly secured between the casing and the sensor unit so as to reduce heat to be transferred to the sensor unit. An infrared sensor and an environmental temperature sensor are installed in the temperature sensing portion.

### FIELD OF THE INVENTION

The present invention relates to clinical thermometers, and particularly to a waterproof infrared ear thermometer. Thereby when the ear thermometer is wiped, no water will permeate into the structure.

### BACKGROUND OF THE INVENTION

Ear thermometers serve to measure the infrared radiation of the interior of the ear so as to get the temperature of the user. Since the ear thermometer is near the heat source of the brain so that the heat source is difficult to be interfered. Thereby using infrared light to measure temperature is not only accurate, but also time-efficient. Thereby the ear thermometers have become a main trend of clinical thermometers. However the current used ear thermometers have no waterproof function. Thus a cover is necessary to be used therewith so that the ear thermometer will not be polluted by the dirt in the ear. This is more important when several uses use the ear thermometer in common.

In the prior art, a sensor unit is placed in front of a sensor head. The sensor unit includes an infrared sensor and an environmental temperature sensor. The infrared sensor servers to receive the infrared light and the environmental thermometer serves to measure the temperature of the infrared sensor. Then output pins serves to transfer the measured signals to an operator units so as to calculate the temperature.

This kind of prior art ear thermometer has no waterproof design so that it is difficult to be washed. Thus, it must be used with waterproof cover. Each time when measuring, the ear thermometer must be covered by a cover. Not only more work is necessary and when it is used for a longer time, the cost of the cover is also a burden. Thereby if no cover, the ear thermometer can no be used.

Thereby it is a trend that the infrared ear thermometer is not used with cover. With reference to FIG. 4, one prior art ear thermometer is illustrated. The sensor head 90 of the ear thermometer has a waterproof structure. A waterproof washer 93 is placed between a casing 91 of the sensor head 90 and a heat dissipating block 92. Another waterproof washer 93 is installed between the heat dissipating block 92 and a sensor 94. Then a supporting post 95 is used to firmly secure the structure. Thereby the waterproof washers 93 are fixed so as to achieve the effect of waterproof.

However this structure must be used with two waterproof washers 93. The water-proof washers 93 have round structures and are minor. Furthermore, the structure of the sensor head 90 with two waterproof washers 93 is complicated. Thereby although the prior art waterproof ear thermometer has the function of waterproof, but it has a complicated structure.

### SUMMARY OF THE INVENTION

Accordingly, the primary object of the present invention is to provide a waterproof infrared ear thermometer which comprises a casing containing the sensor head; a front end of the casing being a hollowed long tube; a sensor unit and a heat dissipating block being received in the casing; a front end of the sensor unit being a temperature sensing portion; an outer front ring of the temperature sensing portion having a forward protruded water-proof washer; and a front end of the casing being protruded with a stopper; the stopper being buckled in an inner edge of the water-proof washer so as to achieve the affect of preventing liquid from flowing into the sensor head. A heat dissipating block is firmly secured between the casing and the sensor unit so as to reduce heat to be transferred to the sensor unit. An infrared sensor and an environmental temperature sensor are installed in the temperature sensing portion.

The various objects and advantages of the present invention will be more readily understood from the following detailed description when read in conjunction with the appended drawing.

### BRIEF DESCRIPTION OF THE DRAWINGS

FIG. 1 is a schematic perspective view of the sensor head of the waterproof infrared ear thermometer of the present invention.

FIG. 2 is a cross sectional view about the sensor head of the waterproof infrared ear thermometer.

FIG. 3 is an enlarged view about the sensor unit of the sensor head of the waterproof infrared ear thermometer according to the present invention.

FIG. 4 is a structural cross sectional view of the waterproof structure of the waterproof infrared ear thermometer according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

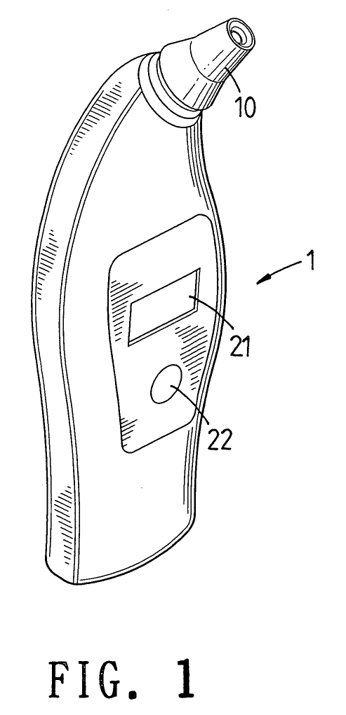

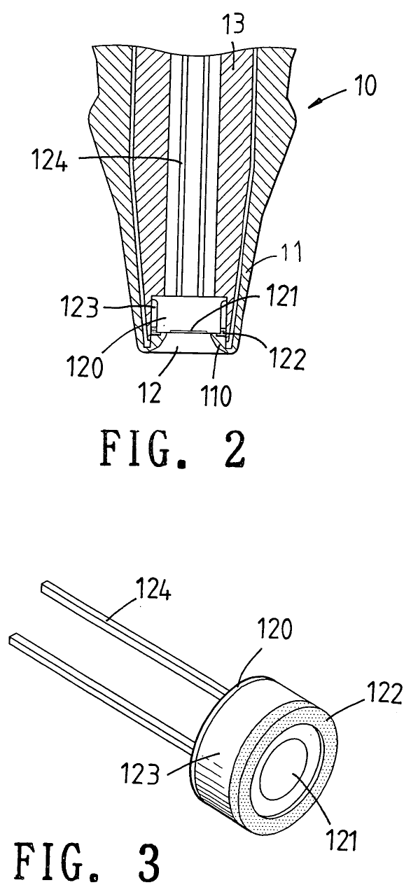

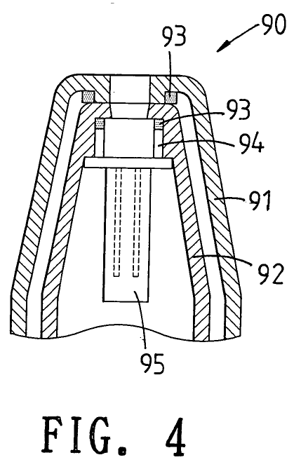

With reference to FIGS. 1 to 3, the structure of the present invention is illustrated. The waterproof infrared ear thermometer comprise the following elements.

A body 1 has a sensor head 10, a display 21 and a control button 22 for switching and controlling. The sensor head 10 serves to insert into the cochlea of one to be measured for receiving infrared from a heat source. An operator unit (not shown) in the body 1 serves to calculate the temperature and then the temperature value is displaced on the display 21. However the way for calculation is known in the art and thus the detail will not be described herein.

A casing 11 encloses the sensor head 10. An interior of the sensor head 10 is formed with a receiving space. A front end of the casing 11 is a hollowed long tube so as to be inserted into the ear of the user to receive the infrared light emitted from an interior of the ear. A front end of the casing 11 is protruded with a stopper 110. A sensor unit 12 and a heat dissipating block 13 are received in the casing 11.

A front end of the sensor unit 12 is a temperature sensing portion 120 having an approximate round cylinder shape. An infrared sensor (not shown) and an environmental temperature sensor (not shown) are installed in the temperature sensing portion 120. A lens 121 is formed in a front inner edge of the temperature sensing portion 120. An outer front ring of the temperature sensing portion 120 has a forward protruded water-proof washer 122. An auxiliary heat dissipating sleeve 123 encloses an outer periphery of the temperature sensing portion 120 behind the water-proof washer 122. A rear side of the sensor unit 12 is extended with a plurality of pins 124 for being connected to the operator unit in the body 1 so as to calculate the temperature measured by the sensor unit 12. The temperature is then displayed on the display 21.

The heat dissipating block 13 is firmly secured between the casing 11 and the sensor unit 12. The auxiliary heat dissipating sleeve 123 on the sensor unit 12 serves to reduce the heat convection between the casing 11 and the sensor unit 12 so as not to affect the measured temperature. By the stopper 110 at a front end of the heat dissipating block 13 and the casing 11 will enforce the sensor unit 12 to be fixed to the casing 11. The stopper 110 is firmed secured at an inner side of the waterproof washer 122 so as to have the effect of waterproof.

In use of the sensor head 10 of the present invention, a front end of the casing 11 is inserted into the ear of the user. The radiated infrared light from the ear will pass through the lens 121 of the temperature sensing portion 120 at the front end of the sensor unit 12 so as to be received by the infrared sensor. Then the environmental temperature sensor will measure the environmental temperature near the infrared sensor. The two values are transferred to the operator unit of the body 1 through the output pins 124. The two values are operated to have the measured temperature of one to be measured. Since in the measure process, it is unavoidable that the interior of the ear will contact with the casing 11. The auxiliary heat dissipating sleeve 123 on the sensor unit 12 has the effect of reducing heat to be transferred to the sensor unit 12 so as to increase the accuracy of the measured body temperature.

When washing the sensor head 10, since a front end of the sensor head 10 has the lens 121, liquid cannot permeate into the temperature sensing portion 120. The waterproof washer 122 is at the outer periphery of the sensor unit 12 and the stopper 110 at a front end of the casing 11 are buckled to the inner edge of the water-proof washer 122. Thereby liquid will not permeate into the sensor head 10. Thus the interior elements in the sensor head 10 will not wear, rust or destroy.

Furthermore, in the present invention, the auxiliary heat dissipating sleeve is integrally formed with the water-proof washer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A waterproof infrared ear thermometer comprising:
a casing containing the sensor head; an interior of the sensor head being formed with a receiving space; a front end of the casing being a hollowed long tube; a sensor unit and a heat dissipating block being received in the casing;
a front end of the sensor unit being a temperature sensing portion;
an outer front ring of the temperature sensing portion having a forward protruded water-proof washer; and
a front end of the casing being protruded with a stopper; the stopper being buckled in an inner edge of the water-proof washer so as to achieve the affect of preventing liquid from flowing into the sensor head.

2. The waterproof infrared ear thermometer as claimed in claim 1, wherein a heat dissipating block is firmly secured between the casing and the sensor unit so as to reduce heat to be transferred to the sensor unit.

3. The waterproof infrared ear thermometer as claimed in claim 1, wherein an infrared sensor and an environmental temperature sensor are installed in the temperature sensing portion.

4. The waterproof infrared ear thermometer as claimed in claim 1, wherein an auxiliary heat dissipating sleeve encloses an outer periphery of the temperature sensing portion behind the waterproof washer.

5. The waterproof infrared ear thermometer as claimed in claim 4, wherein a rear side of the sensor unit is extended with a plurality of pins for being connected to the operator unit in the body so as to calculate the temperature measured by the sensor unit.

6. The waterproof infrared ear thermometer as claimed in claim 1, further comprising a display.

7. The waterproof infrared ear thermometer as claimed in claim 1, wherein the auxiliary heat dissipating sleeve is integrally formed with the water-proof washer.

8. The waterproof infrared ear thermometer as claimed in claim 1, wherein a lens is formed in a front inner edge of the temperature sensing portion.
